(19) United States
(12) Patent Application Publication
(10) Pub. No.: US 2010/0088547 A1
(43) Pub. Date: Apr. 8, 2010

(54) COMPUTER MOTHERBOARD AND POWER-ON SELF-TEST METHOD THEREOF

(75) Inventor: FENG-HUA CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/257,365

(22) Filed: Oct. 23, 2008

(30) Foreign Application Priority Data
Oct. 6, 2008 (CN) 200810304735.8

(51) Int. Cl. G06F 11/22; G06F 15/177

(52) U.S. Cl. 714/36; 713/2; 714/E11.149

(57) ABSTRACT

An exemplary computer motherboard of a computer includes a basic input output system (BIOS) chip having a detecting module, a plurality of function elements, and a control chip connected to the BIOS chip. The control chip includes a plurality of detecting pins each corresponding to a corresponding one of the plurality of function elements. Each of the plurality of detecting pins is grounded via a switch. Each of the plurality of detecting pins is connected to a power source via a resistor. The detecting module of the BIOS chip is configured for detecting voltage levels of the plurality of detecting pins of the control chip, and controlling power states of the plurality of function elements according to the voltage levels of the plurality of detecting pins of the control chip.

### BACKGROUND

1. Technical Field

The present disclosure relates to computer motherboards and power-on self-test (POST) methods, and in particular, to a computer motherboard and a POST method of the computer motherboard.

2. Description of Related Art

Many function elements, such as video cards, network cards, sound cards, will start to work when a computer is first booted up. However, if a user only uses some function elements that perform simple functions, such as editing a text document, the user may not require use of the other function elements. However, these function element will still be using power, which wastes electricity and money.

What is needed is to provide a system and method to overcome the above-described shortcomings.

### BRIEF DESCRIPTION OF THE DRAWINGS

FIG. 1 is a circuit diagram of an exemplary embodiment of a computer motherboard.

FIG. 2 is a flowchart of an exemplary embodiment of a power-on self-test (POST) method of the computer motherboard of FIG. 1.

### DETAILED DESCRIPTION

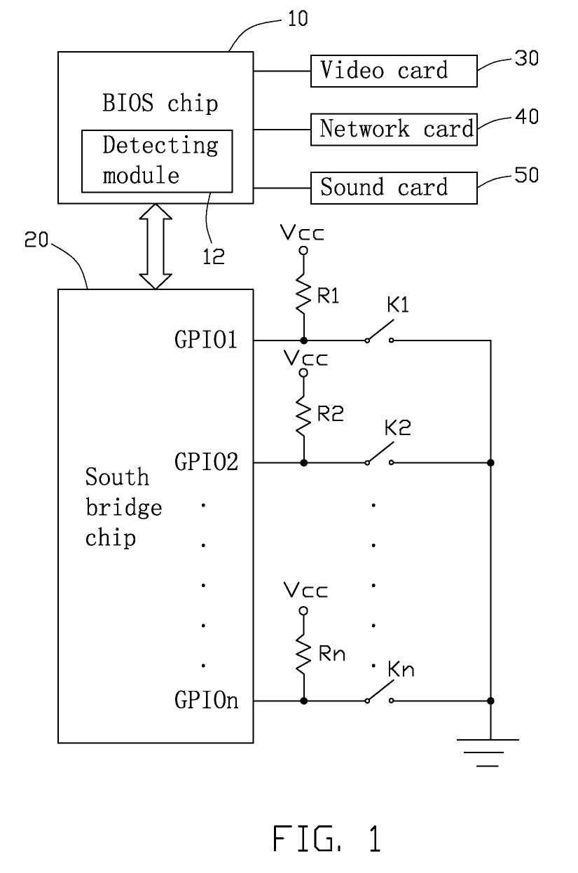

Referring to FIG. 1, an exemplary embodiment of a computer motherboard of a computer includes a basic input output system (BIOS) chip 10 storing a power-on self-test (POST) program, a control chip, such as a south bridge chip 20, a plurality of switches K1, K2 . . . Kn, and a plurality of resistors R1, R2 . . . Rn. In one embodiment, the control chip may be a super input output (SIO) chip.

The south bridge chip 20 includes a plurality of detecting pins such as general purpose input output (GPIO) pins GPIO1, GPIO2 . . . GPIOn. Each of the plurality of GPIO pins GPIO1, GPIO2 . . . GPIOn is grounded via one of the plurality of switches K1, K2 . . . Kn correspondingly. Each of the plurality of GPIO pins GPIO1, GPIO2 . . . GPIOn is connected to a power source Vcc, such as a 5V power source on the computer motherboard, via one of the plurality of resistors R1, R2 . . . Rn correspondingly. When one of the plurality of switches K1, K2 . . . Kn is turned off, the GPIO pin of the one of the plurality of GPIO pins GPIO1, GPIO2 . . . GPIOn is at a high voltage level, such as about 5V for example. When one of the plurality of switches K1, K2 . . . Kn is turned on, the GPIO pin of the one of the plurality of GPIO pins GPIO1, GPIO2 . . . GPIOn is at about a 0 volts. The plurality of switches K1, K2 . . . Kn are corresponding to a plurality of function elements may including a video card 30, a network card 40, and a sound card 50, etc., mounted on the computer motherboard. The BIOS chip 10 is connected to the south bridge chip 20.

The BIOS chip 10 includes a detecting module 12 configured for detecting the voltage levels of the plurality of GPIO pins GPIO1, GPIO2 . . . GPIOn when the POST program is executed. When the plurality of GPIO pins GPIO1, GPIO2 . . . GPIOn are all at the high voltage level, the POST program continues to execute a latter part of the POST program. When one or more of the plurality of GPIO pins GPIO1, GPIO2 . . . GPIOn is/are at the about 0 volts, the detecting module 12 turns off the function elements corresponding to the one or more of the GPIO pins of the plurality of GPIO pins GPIO1, GPIO2 . . . GPIOn at the about 0 volts, therefore, the corresponding function elements will not be powered.

In another embodiment, the POST program can continue executing the latter part of the POST program when the plurality of GPIO pins GPIO1, GPIO2 . . . GPIOn are all at the about 0 volts. In such a case, when one or more of the plurality of GPIO pins GPIO1, GPIO2 . . . GPIOn is/are are at the high voltage level, the detecting module 12 turns off the function elements corresponding to the one or more of the GPIO pins of the plurality of GPIO pins GPIO1, GPIO2 . . . GPIOn at the high volts level, therefore, the corresponding function elements will not be powered.

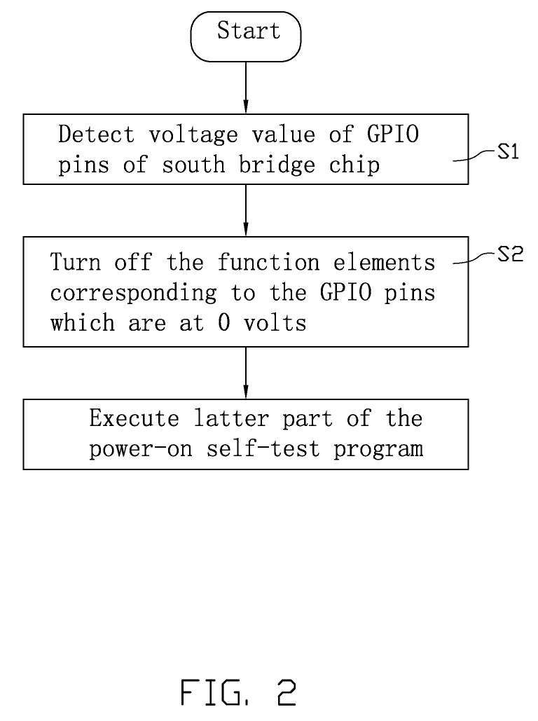

Referring to FIG. 2, an exemplary embodiment of a POST method of the above-mentioned computer motherboard includes following blocks.

In block S1, the POST program of the BIOS chip 10 is executed and the detecting module 12 detects the voltage levels of the plurality of GPIO pins GPIO1, GPIO2 . . . GPIOn when the computer is booted up.

In block S2, the detecting module 12 controls power states of the function elements to be turned off when the voltage levels of the corresponding GPIO pins of the south bridge chip 20 are at about 0 volts, and then executes the latter part of the POST program.

For example, if a user only wants to edit a simple text document of the computer, the user can turn off one or more of the plurality of switches K1, K2 . . . Kn corresponding to one or more non-used function elements such as the video card 30 of the computer motherboard before booting up the computer. When the computer is booted up, since the one or more of the plurality of switches K1, K2 . . . Kn is/are turned off, the corresponding function elements will not be powered by executing the detecting module 12 of the POST program of the BIOS chip 10, which can save electrical energy effectively.

In another embodiment, after the detecting module 12 detecting the voltage levels of the plurality of GPIO pins GPIO1, GPIO2 . . . GPIOn, the detecting module 12 controls power states of the function elements to be turned off when the voltage levels of the corresponding GPIO pins of the south bridge chip 20 are at high voltage level, and then executes the latter part of the POST program.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer motherboard of a computer, comprising:
a basic input output system (BIOS) chip comprising a detecting module;
a plurality of function elements; and
a control chip connected to the BIOS chip, the control chip comprising a plurality of detecting pins, wherein each of the plurality of detecting pins correspond to a corresponding one of the plurality of function elements, wherein each of the plurality of detecting pins is grounded via a switch, each of the plurality of detecting pins is connected to a power source via a resistor;
wherein the detecting module of the BIOS chip is configured for detecting voltage levels of each of the plurality of detecting pins of the control chip, and controlling power states of the plurality of function elements according to the voltage levels of the plurality of detecting pins of the control chip.

2. The computer motherboard of claim 1, wherein when the voltage levels of one or more of the plurality of detecting pins of the control chip is/are at about 0 volts, the detecting module of the BIOS chip turns off one or more of the plurality of function elements corresponding to the one or more of the detecting pins at the about 0 volts.

3. The computer motherboard of claim 1, wherein when the voltage levels of one or more of the plurality of detecting pins of the control chip is/are at a high voltage level, the detecting module of the BIOS chip turns off one or more of the plurality of function elements corresponding to the one or more of the detecting pins at the high voltage level.

4. The computer motherboard of claim 1, wherein the control chip is a south bridge chip.

5. The computer motherboard of claim 1, wherein the plurality of detecting pins are general purpose input output (GPIO) pins.

6. The computer motherboard of claim 1, wherein the power source is a 5V power source on the computer motherboard.

7. The computer motherboard of claim 1, wherein the plurality of function elements comprises at least one of a video card, a network card, and a sound card mounted on the computer motherboard.

8. A power-on self-test (POST) method of a computer motherboard, comprising:
(a) providing: a basic input output system (BIOS) chip comprising a detecting module;
a plurality of function elements; and
a control chip connected to the BIOS chip, the control chip comprising a plurality of detecting pins, wherein each of the plurality of detecting pins correspond to a corresponding one of the plurality of function elements, wherein each of the plurality of detecting pins is grounded via a switch, each of the plurality of detecting pins is connected to a power source via a resistor;
(b) detecting voltage levels of the plurality of detecting pins of the control chip via the detecting module of the BIOS chip; and
(c) controlling power states of the plurality of function elements corresponding to the plurality of detecting pins of the control chip according to the voltage levels of the plurality of detecting pins of the control chip.

9. The POST method of claim 8, wherein in block (c), when that the voltage levels of the one or more detecting pins of the control chip is/are at about 0 volts, the detecting module of the BIOS chip turns off one or more of the plurality of function elements corresponding to the one or more of the plurality of detecting pins at the about 0 volts.

10. The POST method of claim 8, wherein in block (c), when that the voltage levels of the one or more detecting pins of the control chip is/are at a high voltage level, the detecting module of the BIOS chip turns off one or more of the plurality of function elements corresponding to the one or more of the plurality of detecting pins at the high voltage level.

11. The POST method of claim 8, wherein the control chip is a south bridge chip.

12. The POST method of claim 8, wherein the plurality of detecting pins are general purpose input output (GPIO) pins.

13. The POST method of claim 8, wherein the power source is a 5V power source on the computer motherboard.

14. The POST method of claim 8, wherein the plurality of function elements comprises at least one of a video card, a network card, and a sound card mounted on the computer motherboard.
